(19) United States
(12) Patent Application Publication
(10) Pub. No.: US 2009/0037288 A1
(43) Pub. Date: Feb. 5, 2009

(54) RECIPE MANAGEMENT AND EXECUTION SYSTEMS AND METHODS

(76) Inventor: Michael J. Christensen, Redmond, WA (US)

Correspondence Address: AXIOS LAW GROUP. PLLC, 1525 FOURTH AVENUE, SUITE 800, SEATTLE, WA, 98101, US

(21) Appl. No.: 12/184,930

(22) Filed: Aug. 1, 2008

Related U.S. Application Data
(60) Provisional application No. 60/953,979, filed on Aug. 3, 2007.

(51) Int. Cl. G06Q 30/00; G06F 7/06; G06F 17/30; G06F 3/00

(52) U.S. Cl. 705/26; 707/3; 708/133; 707/E17.014

(57) ABSTRACT

Systems and methods are provided herein that provide for recipe management and execution.

### RELATED REFERENCES

This application claims priority to U.S. Provisional Application 60/953,979 filed Aug. 3, 2007. The foregoing application is hereby incorporated by reference in its entirety as if fully set forth herein.

### FIELD

This invention relates generally to recipes, methods or routines, and more specifically, to systems and methods for the management and execution of recipes, methods or routines.

### BACKGROUND

Until the advent of the internet, when people wanted to buy groceries for cooking they were typically required to go to a grocery store to purchase all the items that they needed. Delivery of groceries from orders made by phone or mail were possible, but were not an efficient means of regularly ordering groceries and these orders could not always be placed on weekends or at night. Today, online grocers allow cooks to order food at any time and have it quickly delivered to their home or business, and these services have steadily increased in popularity.

Along with requiring food to prepare, cooks also typically need recipes to guide them in the preparation of meals and individual food products. Recipes may be passed from person to person through oral tradition or created through trial and error, but the most efficient method of leaning new recipes is to obtain them in written form. Traditionally, recipes may be found in cook-books, advertisements and on product packaging, but the internet has made recipes widely available in electronic form, which may be easily searched and communicated to others. Many websites exists today that allow users to search for recipes by criteria such as type of cuisine, origin of the cuisine, and by main ingredient, to name a few. These websites allow users to quickly find and download new and interesting recipes.

### BRIEF DESCRIPTION OF THE DRAWINGS

The present invention will be described by way of exemplary embodiments but not limitations, illustrated in the accompanying drawings in which like references denote similar elements, and in which:

FIG. 1 is a pictorial diagram of a system of interconnected devices that facilitate management and execution of recipes, methods or routines.

FIG. 2 is a block diagram of a device that provides an exemplary operating environment for various embodiments.

FIG. 3 is an illustration of a recipe search module in accordance with an embodiment.

FIG. 4 is an illustration of a recipe input module in accordance with an embodiment.

FIG. 5 is an illustration of a recipe scheduling module in accordance with an embodiment.

FIG. 6 is an illustration of a shopping list generation and recipe scheduling module in accordance with an embodiment.

FIG. 7 is a diagram illustrating actions taken by a user device, recipe server and a product provider in accordance with an embodiment.

FIG. 8 is a block diagram illustrating a routine for generating and submitting a request for ingredients in accordance with various embodiments.

FIG. 9 is a diagram illustrating actions taken by a user device and recipe server in accordance with an embodiment.

FIG. 10 is a block diagram illustrating the actions for creating and saving a normalized recipe in accordance with various embodiments.

FIG. 11 is a block diagram illustrating an ingredient normalization sub-routine in accordance with various embodiments.

FIG. 12 is a block diagram illustrating the actions taken when creating and saving a list of one or more recipe in accordance with various embodiments.

FIG. 13 is a diagram illustrating actions taken by a user device, recipe server and a product provider in accordance with an embodiment.

FIG. 14 is a block diagram illustrating a shopping list generation routine in accordance with an embodiment.

### DESCRIPTION

Illustrative embodiments presented herein include, but are not limited to, systems and methods for management and execution of recipes.

Various aspects of the illustrative embodiments will be described using terms commonly employed by those skilled in the art to convey the substance of their work to others skilled in the art. However, it will be apparent to those skilled in the art that the embodiments described herein may be practiced with only some of the described aspects. For purposes of explanation, specific numbers, materials and configurations are set forth in order to provide a thorough understanding of the illustrative embodiments. However, it will be apparent to one skilled in the art that the embodiments described herein may be practiced without the specific details. In other instances, well-known features are omitted or simplified in order not to obscure the illustrative embodiments.

Further, various operations and/or communications will be described as multiple discrete operations and/or communications, in turn, in a manner that is most helpful in understanding the embodiments described herein; however, the order of description should not be construed as to imply that these operations and/or communications are necessarily order dependent. In particular, these operations and/or communications need not be performed in the order of presentation.

The phrase “in one embodiment” is used repeatedly. The phrase generally does not refer to the same embodiment; however, it may. The terms “comprising,” “having” and “including” are synonymous, unless the context dictates otherwise. The following illustrations of various embodiments use the term “recipe” by way of example to describe the various embodiments, but this should be construed to encompass and provide for terms such as “method” and “routine” and the like.

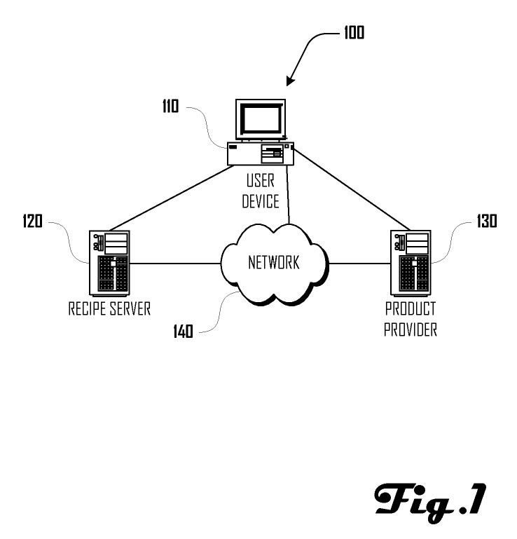

FIG. 1 illustrates a plurality of devices used in an exemplary system 100 of one embodiment. The system 100 comprises a user device 110, a recipe server 120, and a product provider 130, which are operationally connected via a network 140. Additionally, the user device 110 may be directly operationally connected with the recipe server 120 and the product provider 130.

In some embodiments, there may be one or more user device 110, recipe server 120, product provider 130 or network 140 and such devices may be in remote locations, be in relatively close proximity to each other, or be embodied in the same device. In one embodiment, the user device 110 may be used by various types of persons, businesses or other entities. In one embodiment, the product provider 130 may be various persons, businesses or other entities that may provide one or more good or service. In another embodiment, the user device 110 may be a personal computer, laptop computer, cellular telephone, personal data assistant, audio player, gaming device, or the like. In a still further embodiment, the user device 110 may be a computer embodied in a home appliance such as a refrigerator, oven, microwave oven, toaster, or the like.

In a further embodiment, the product provider 130 may be an online grocer such as Peapod.com, Amazon.com, Safeway.com, Albertsons.com, lgourmet.com, Groceries-Express.com, NetGrocer.com, CoopGrocer.com, Woolworths.com, or the like.

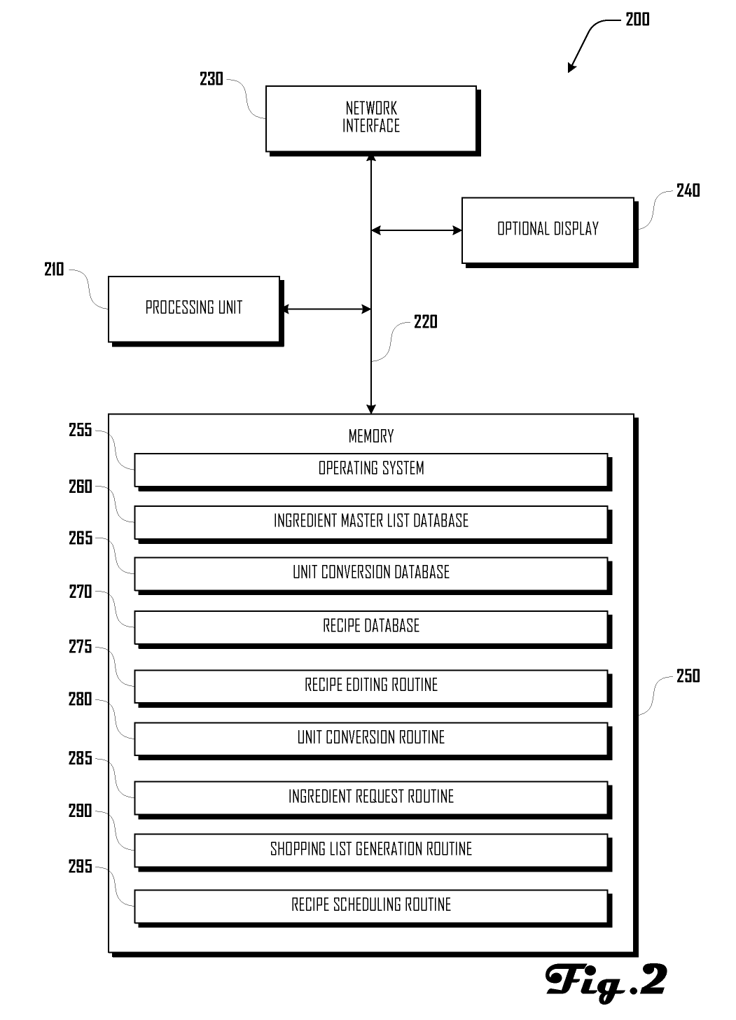

FIG. 2 illustrates several components of an exemplary operating environment 200 for an embodiment. For example, the recipe server 120 may be embodied in the operating environment 200 depicted in FIG. 2. The operating environment 200 may include many more components than those shown in FIG. 2 in some embodiments. However, it is not necessary that all of these generally conventional components be shown in order to disclose an enabling embodiment for practicing the embodiments described herein. As shown in FIG. 2, the operating environment 200 includes a network interface 230 for connecting to remote devices (not shown). The network interface 230 may be a network interface designed to support a local area network (LAN), wireless local area network (WLAN), personal area network (PAN), telephone network, powerline connection, serial bus, universal serial bus (USB) wireless connection, or the like. The network interface 230 includes the necessary circuitry, driver and/or transceiver for such a connection and is constructed for use with the appropriate protocols for such a connection.

The operating environment 200 also includes a processing unit 210, an optional display 240 and a memory 250, all interconnected along with the network interface 230 via a bus 220. In various embodiments, the display 240 may not be necessary in all forms of computing devices and, accordingly, is an optional component. The memory 250 generally comprises random access memory (“RAM”), a read only memory (“ROM”) and a permanent mass storage device, such as a disk drive, flash RAM, or the like. The memory 250 stores the program code necessary for a recipe editing routine 275, a unit conversion routine 280, an ingredient request routine 285, a shopping list generation routine 290, and a recipe scheduling routine 295. Additionally, the memory 250 stores an operating system 255, an ingredient master list database 260, a unit conversion database 265, and a recipe database 270.

It will be appreciated that the software components may be loaded from a computer readable medium into memory 250 of the operating environment 200 using a drive mechanism (not shown) or network mechanism (not shown) associated with the computer readable medium, such as a floppy, tape, digital versatile disc (DVD)/CD-ROM drive, blu-ray disc, flash RAM, network interface card, or the like.

Although an exemplary operating environment 200 has been described that generally conforms to a conventional general-purpose computing device, an operating environment 200 may be any of a great number of devices capable of functioning as a device, server or operating environment that is within the spirit or scope of the embodiments described herein or may perform at least one function of the embodiments described herein.

In one exemplary embodiment, a user device 110 may configure or interact with the operating environment 200 using a graphical user interface. An example of a graphical user interface is an interactive web page, e.g., in HTML (HyperText Markup Language), Flash, JavaScript, VBScript, JScript, ASP.NET, PHP (HTML Preprocessor) or XHTML (eXtensible HyperText Markup Language) form, or the like. Resultantly, since users are generally familiar with the user interfaces of web pages, including sophisticated web pages such as Flash-enabled web pages from Macromedia, Incorporated of San Francisco, Calif., consumption of peer to peer device services using a web page based graphical user interface on a peer to operating environment 200 (e.g., displayed on the peer to peer display 240) may be made familiar and user friendly.

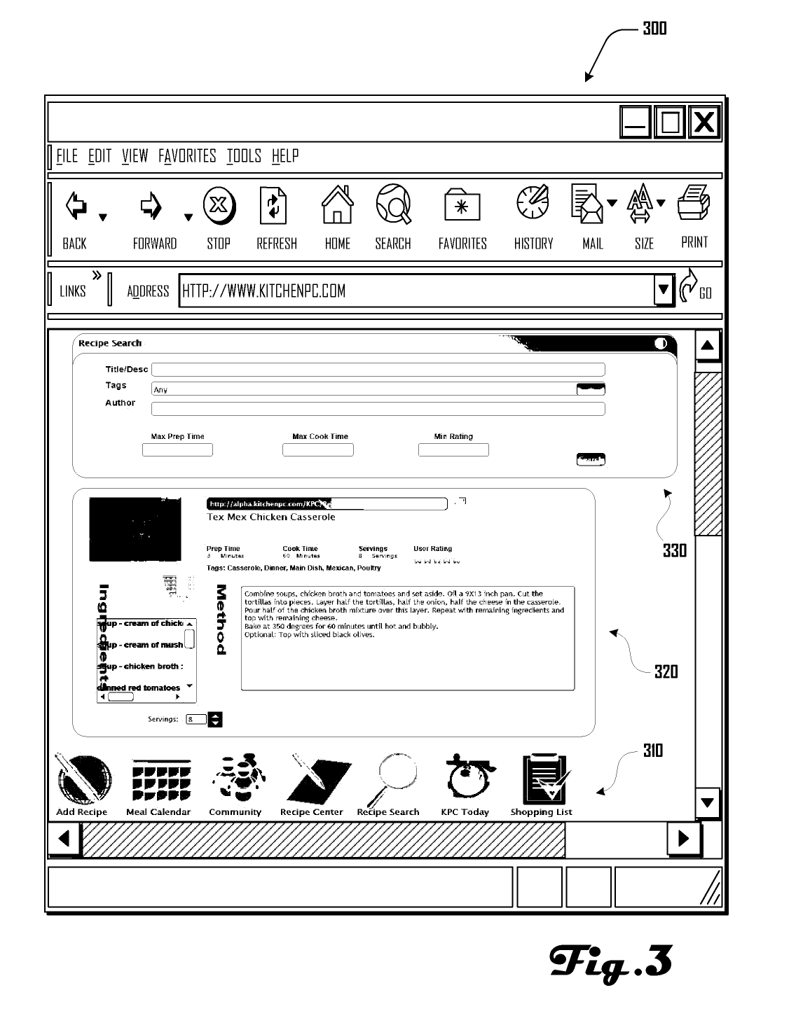

The following FIGS. 3-6 depict an exemplary user interface that provides for recipe search and execution, in accordance with various embodiments. Although specific embodiments are depicted herein, further embodiments comprise various modifications of a graphic user interface. Therefore, the following Figures should be viewed as only exemplary and not limiting of the various embodiments that are possible.

FIG. 3 is an illustration of a recipe search module 330 and a recipe display module 320 in accordance with an embodiment. Depicted in FIG. 3 is a web browser 300 which is displaying a menu bar 310 and the recipe display module 320 and the recipe search module 330.

The menu bar 310 comprises various icons, which allow a user to open, close, and/or select various modules or applications in accordance with various embodiments. In some embodiments, a user can click an icon with a cursor to select a given application or module.

The recipe display module 320 comprises fields that are operable to display and/or configure various aspects of a recipe. For example, the recipe display module may include a field to display recipe ingredients, the method of performing the recipe, recipe tags, cook time, preparation time, serving size, user rating, an image of the food resulting from the recipe, URL to the recipe, suggested recipe food pairing, suggested recipe beverage pairings, serving selection, vegetarian conversion, vegan conversion, and the like.

The recipe search module 330 may include various fields that are operable to facilitate a search for a recipe. For example, a recipe search module 330 may include a title search field, a description search field, a keyword search field, an ingredient search field, a tag search field, an author search field, a preparation time search field, a cook time search field, a rating search field, a dietary requirement field, and the like. In various embodiments, a user can search for a recipe using a recipe search module 330 and be presented with one or more recipe that matches search criteria. In some embodiments, a user can select one or more recipe to be displayed in a recipe display module 320.

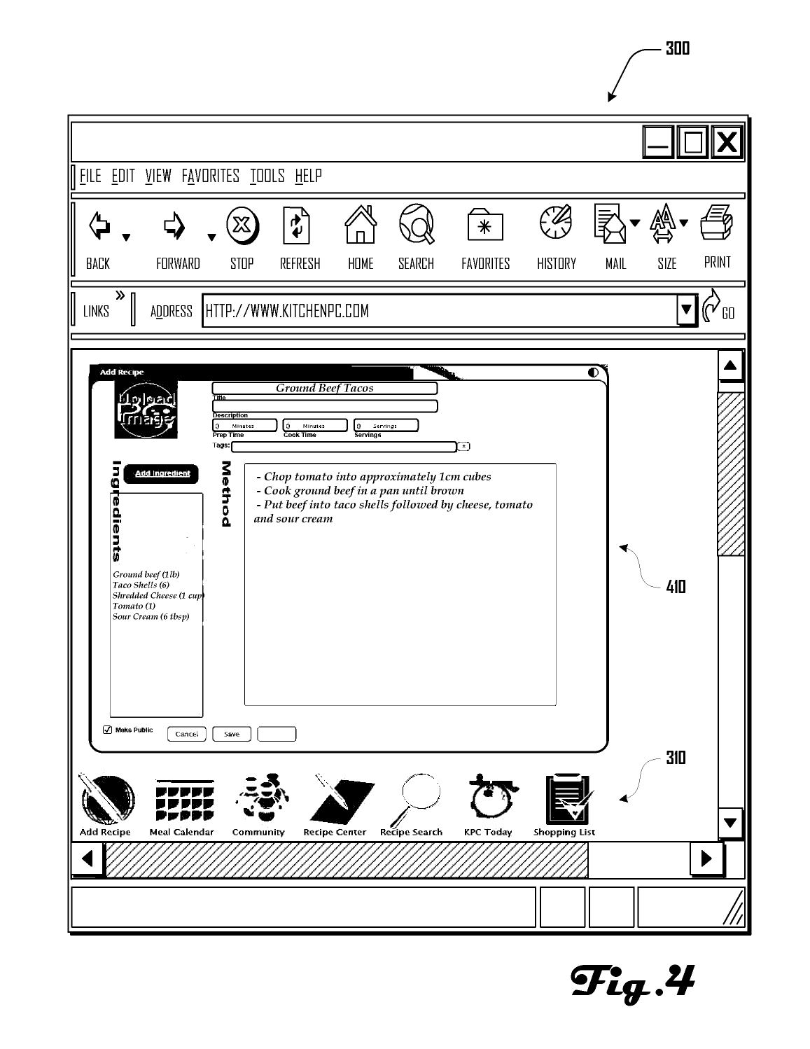

FIG. 4 is an illustration of a recipe input module 410 in accordance with an embodiment. FIG. 4 depicts a web browser 300, which displays a menu bar 310 and a recipe input module 410. In various embodiments, the recipe input module 410 has fields that allow for input and/or configuration of a recipe. For example, a recipe input module can comprise fields such as a title input field, description input field, preparation time input field, cook time input field, serving input field, ingredient input field, preparation method input field, image input field, recipe tag input field, dietary restriction input field, recipe variation input field and the like. For example, as shown in FIG. 4, various fields have been filled, such as fields associated with title, ingredients and method of preparation.

In various embodiments, a recipe input module 410 may be operable to allow a user to input a recipe, which may include one or more ingredient. In some embodiments, a user can select ingredients from a list comprising a plurality of ingredients. In other embodiments, a user may suggest or add ingredients to a list of a plurality of ingredients. In further embodiments, a user can associate one or more tag, attribute or keyword with a given recipe, which may include tags, attributes or keywords such as Italian, Mexican, American, chicken, beef, curry, quick meal, vegetarian, kosher, hot food, cold food, low fat, spicy, and the like.

In a further embodiment, a recipe input module 410 may allow a user to input variations to a recipe. For example, a user may input a primary version of a recipe, but may also input alternative variations, which may be associated with various dietary preferences or other preferences. In some embodiments, such dietary preferences or other preferences may include, spicy, organic, no meat, low fat, low carb, red sauce, white sauce, beef, chicken, fast preparation, and the like. In some embodiments, variations may be selected by a user based on tags, keywords, a menu, a check box, and the like.

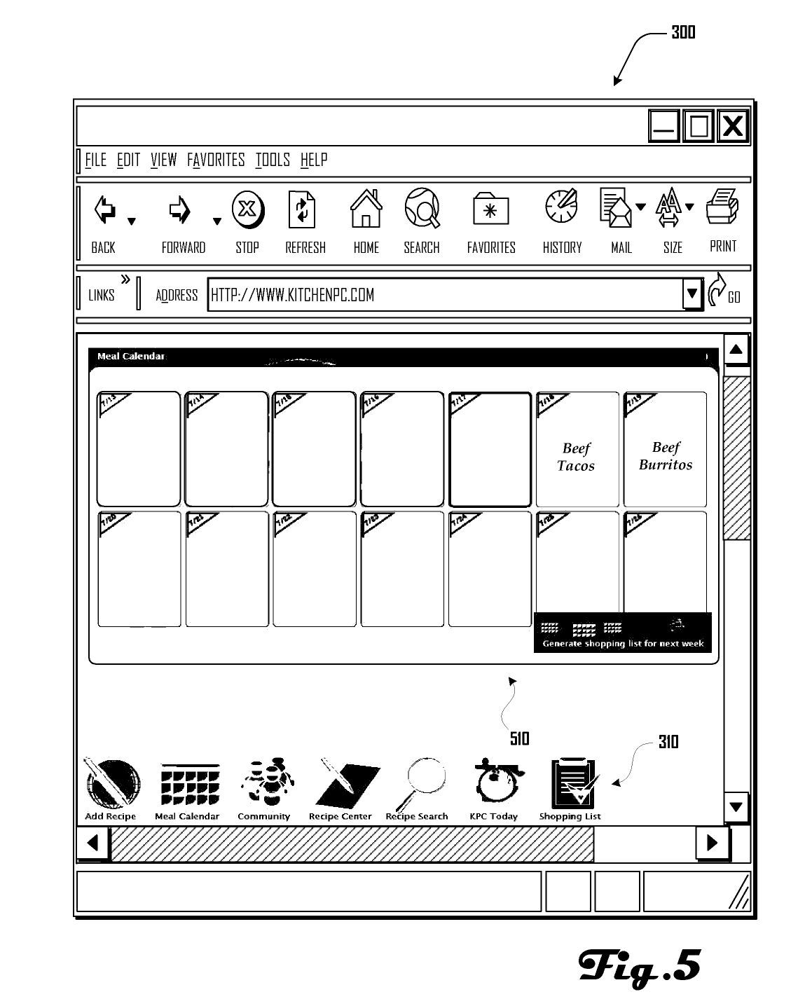

FIG. 5 is an illustration of a recipe scheduling module 510 in accordance with an embodiment. As shown in FIG. 5, there may be a web browser 300 that displays a menu bar 310 and a recipe scheduling module 510. In various embodiments, a user may select one or more recipe and associate the recipe with a given day on a calendar. In further embodiments, a user may drag and drop recipes from one day to another. For example, as shown in FIG. 5, the recipe “Beef Tacos” has been associated with the date July 18th, and the recipe “Beef Burritos” has been associated with the date July 19th.

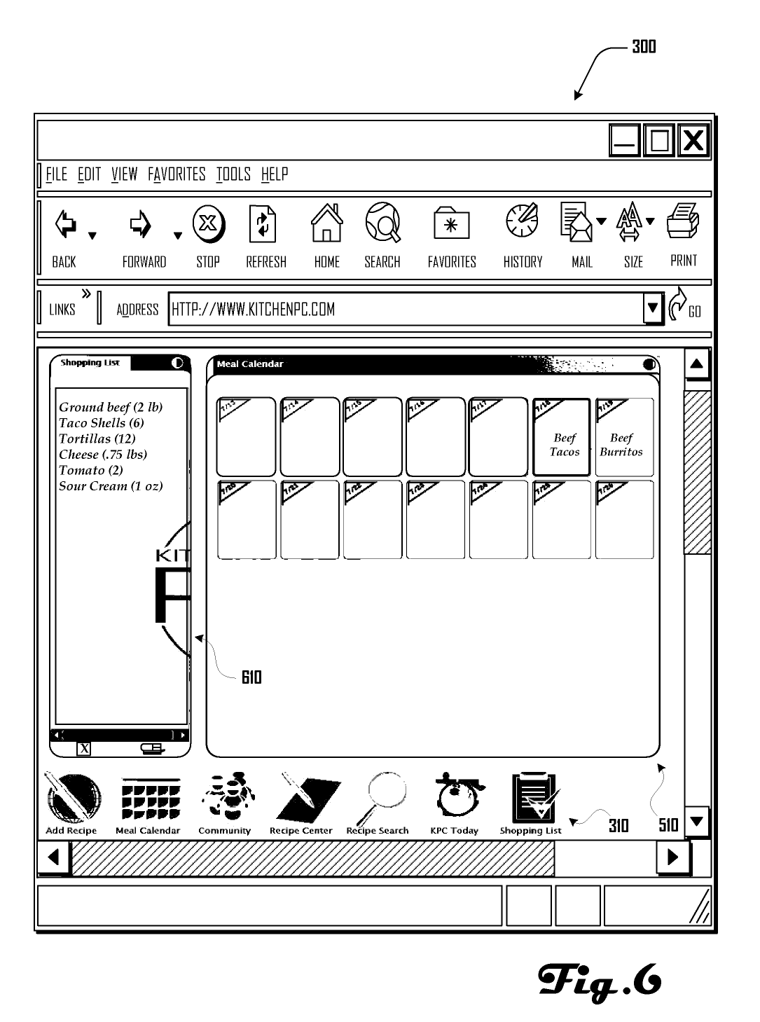

FIG. 6 is an illustration of a shopping list generation module 610 and recipe scheduling module 510 in accordance with an embodiment. As shown in FIG. 6, there may be a web browser that displays a menu bar 310 and the shopping list generation module 610 and the recipe scheduling module 510. In one embodiment, a user may select a single recipe and generate a shopping list therefrom. In another embodiment, a user may select a date range, or the like, and generate a shopping list from recipes that may be associated with dates within the date range.

In various embodiments, a user may add or remove ingredients from a generated shopping list, modify the quantify of one or more ingredient on a shopping list, add or remove ingredients from one or more recipe from a shopping list, and the like. In further embodiments, a shopping list can be printed, e-mailed, sent in a text message, or uploaded to a product provider 130.

In the exemplary embodiment depicted in FIG. 6, a user selects a date range that comprises July 18 and July 19 and therefore includes the recipes for “Beef Tacos” and “Beef Burritos.” Accordingly, a shopping list comprising the ingredients from both recipes can be generated and displayed. In various embodiments, similar or identical ingredients from recipes can be combined into a single item in a shopping list. For example, the recipe for “Beef Tacos” may include the ingredient “Shredded Cheese” and the recipe for “Beef Burritos” may simply include the ingredient “Cheese.” A determination may be made that these ingredients are equivalent and these ingredients may be combined into a single shopping list item for “Cheese.”

In some embodiments, units and quantities of a given ingredient can be modified to match retail units or quantities. For example, cheese may be sold by weight in pounds, and therefore, if a recipe calls for “1 Cup of shredded cheese” (as shown in FIG. 5) a determination can be made as to how many pounds of cheese is present in one cup of shredded cheese, and the ingredient unit can be converted into pounds of cheese. Additionally, the recipe for “Beef Burritos” may simply call for “0.5 pounds of cheese” and therefore the amounts of cheese, in pounds, needed for each recipe can be combined when a shopping list is created that encompasses both recipes.

In another embodiment a user can generate a shopping list or ingredient list from one or more selected recipe. Additionally, a user may edit or configure the shopping list and may upload or otherwise communicate the shopping list to a product provider 130 or the like. In a further embodiment, there may be a plurality of users that may selectively communicate with each other. For example, a user may create a profile and may associate the user's profile with other user profiles as “friends,” and the like. Associated users may share recipes, cooking tips, recipe ratings, recipe schedules, shopping lists, product orders, and the like.

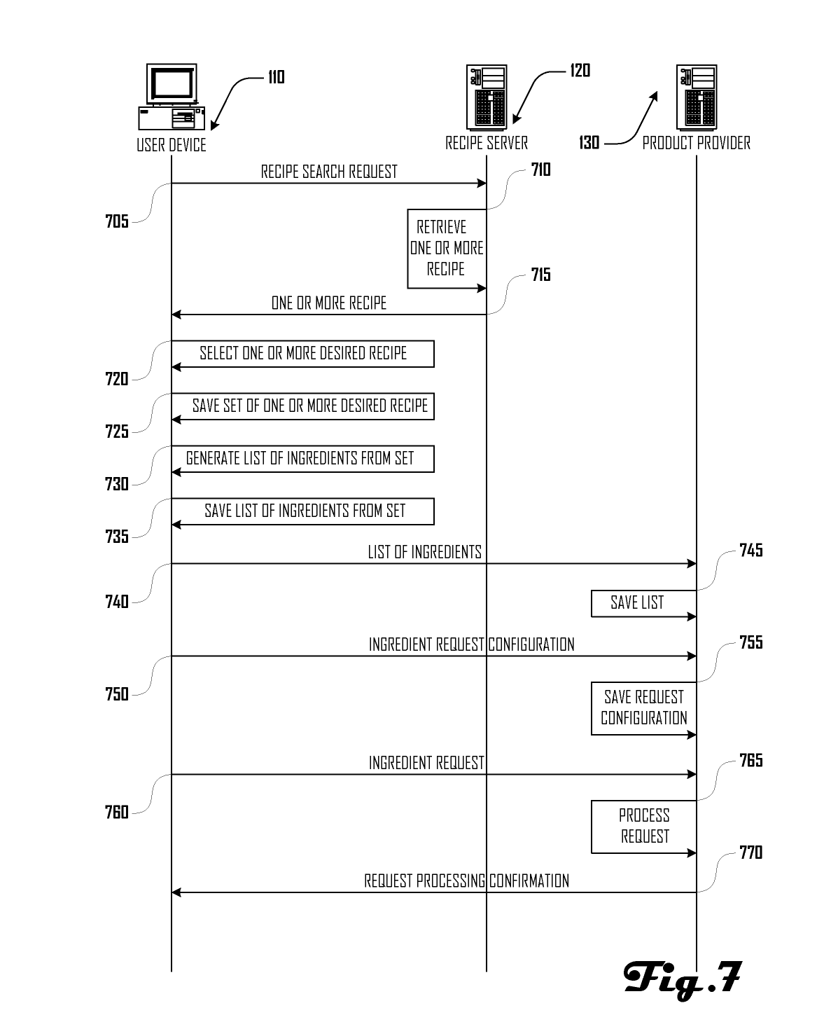

In still further embodiments, users can send, receive, post or view messages to other users. In some exemplary embodiments, a user may create a blog, send an e-mail, post a message to a message board, initiate a chat, and the like. Social networking functionalities such as these and others are well known in the art. Websites such as MySpace.com and FaceBook.com provide examples of social networking functionalities and capabilities that are within the scope and spirit of various embodiments; however, additional embodiments comprise a multitude of social networking functionalities and capabilities. FIG. 7 is a diagram illustrating one exemplary series of communications between a user device 110, a recipe server 120, and a product provider 130 during the management and execution of a recipe, method or routine in accordance with various embodiments. The communications begin with the user device 110 sending 705 a recipe search request to the recipe server 120 and the recipe server 120 retrieving 710 one or more recipe, and the recipe server 120 sending 715 the one or more recipe to the user device 110. In one embodiment, a user device 110 may perform a search for recipes based on various criteria including, name, serial number, ingredients, cooking time, preparation time, keyword, tag, calories, recipes in a given list, or the like. In another embodiment, the user device 110 may view all recipes available or view recipes in a hierarchical or categorical form. Various methods of viewing, organizing, and searching items within a set are well known in the art and are within the scope of the embodiments described herein.

Next, one or more desired recipe is selected 720 and the set of one or more desired recipe is saved 725. In one embodiment, a plurality of lists may be created that comprise one or more recipe, and each list may be named or otherwise designated to indicate the set of recipes therein. For example, a list could include recipes such as favorite deserts, low-calorie breakfast, cheap lunch, or quick preparation dinner, or the like.

Returning to FIG. 7, a list of ingredients from the set is then generated 730 from the set of one or more desired recipe and the list of ingredients from the set is saved 735. For example, several recipes will each comprise a plurality of ingredients and a list may be generated that comprises each of the ingredients from the several recipes and the total quantity of those ingredients. Where ingredients are present in at least two of the one or more desired recipe, these ingredients may be combined or merged when the list of ingredients is generated, which removes redundant ingredients from the generated list of ingredients. Merger of ingredients may also include merger of quantity of the ingredients. For example, if there is a first recipe for Chinese fried rice that comprises: 4 cups rice; 1 cup pork; 1 tbsp soy sauce; ½ cup oil; 2 eggs; and ¼ cup peas, and a second recipe for seafood rice salad comprising: 2 cups rice; 7 oz tuna; 8 oz shrimp; and 3 eggs, the generated list of ingredients could be: 6 cups rice, 1 cup pork; 1 tbsp soy sauce; ½ cup oil; 5 eggs; and ¼ cup peas, 7 oz tuna; and 8 oz shrimp.

In one embodiment, recipes and ingredients of recipes may be normalized such that only a limited number of ingredients exist. For example, instead of allowing recipes to contain ingredients such as “Vermont sharp cheddar”, “yellow cheddar”, or “American”, all such distinct designations may be merged into “cheddar cheese.” Ingredients may be normalized very broadly or specifically such as “meat”, “white meat”, “pork”, “ham”, “black forest ham” and the like. Preparation instructions may be abstracted for ingredient names to convey further meaning depending on the usage context of the recipe.

For example, “black forest ham (sliced)” where “black forest ham” is a normalized ingredient in a finite set of defined ingredients and “(sliced)” is a preparation instruction that is specific to the recipe's intended usage of said ingredient. In some embodiments, various scopes of normalization may be imposed on ingredients, one or more normalization may be imposed, or normalization may be changed.

In one embodiment, there may be a database that comprises ingredients in a form that the ingredient is typically sold in a store and there may be a database that comprises ingredients in forms that may be used in a recipe. Additionally, it may be possible to map between these databases and thereby aggregate multiple forms of an ingredient found in one or more recipe.

Accordingly, in various embodiments, a shopping list may be generated from a plurality of recipe ingredients by aggregating like ingredients and converting ingredients to a unit that is typically sold in a store or at an online grocer. This may be desirable in some embodiments because such functionality allows a user to create a personalized shopping list that corresponds to units sold in a store or online grocer without the user having to manually convert and aggregate duplicate recipe ingredients.

Additionally, in one embodiment, recipes themselves do not hold the names of ingredients but merely contain a reference to a specific item in a list of “all known ingredients” that is abstracted from recipe storage itself. Therefore, if an item in the list of “all known ingredients” is changed, the change will globally affect all recipes that reference the changed item. In a further embodiment, items in the list of “all known ingredients” may be sponsored by a product producer such that all recipes that reference the item will display a brand name of the ingredient or other advertisement or entry as defined by the sponsor, as described herein.

In another embodiment, recipes may be linked together by a common ingredient. For example, a user who is interested in a recipe that calls for 2 salted quail eggs (or another obscure ingredient) may view other recipes which call for the same ingredient generally or in a specific designated quantity. Accordingly, users who already possess or intend to request a specific quantity of an ingredient may obtain recipes that will maximize the use of that specific quantity (e.g. a user who cannot buy quail eggs in a quantity of less than 12 and does not want such surplus to go to waste).

In yet another embodiment, ingredients or items in an “all known ingredients” list may be mapped or associated with the Stock Keeping Unit (SKU) information of a retailer of said ingredient, which may facilitate, among other things, the item being added to the “shopping cart” function of an online grocer. In a still further embodiment, information may be stored about individual ingredients or items in an “all known ingredients” list in a centralized manner such as nutritional information, units of measurement used, seasonal information, wine pairings, and the like.

In one embodiment, a user may enter specific information about ingredients. For example, the system could know if the user is allergic to walnuts and not display any recipes that comprise this ingredient, or present a warning that the ingredient is present in a recipe. Similarly, users with certain cooking styles, religious beliefs, or other attributes of a user's character that would be associated with the food they would eat could receive warnings or other indications when recipes or ingredients violate defined rules of said user's preference.

In one embodiment the list of ingredients may be modified. For example, ingredients may be removed or the quantity reduced, when a user already possesses the ingredient or possesses some, but not enough of the ingredient. Additionally, ingredients may be added or quantity increased if a user so desires. In another embodiment, ingredients of a given recipe may be multiplied, divided or otherwise modified to conform to the number of persons that a user desires to serve the product of the given recipe, which need not be uniform for each recipe. Additionally, a recipe or ingredient may be modified, changed, or exchanged such that the ingredient or recipe becomes vegetarian compliant, vegan compliant, or the like.

Returning to the series of communications in FIG. 7, the list of ingredients is sent 740 to the product provider 130, the list of ingredients is saved 745, a request for ingredients is configured 750 and saved 755, and a request for ingredients is submitted 760 and then the request for ingredients is processed 765 by the product provider 130. The product provider 130 presents a confirmation of the request being processed 770, which in some embodiments is optional.

In one embodiment, the product provider 130 is an online grocer as described herein, and the list of ingredients may be pre-populated in the “shopping cart” functionality of such a website. A user may then choose to add, remove, or otherwise configure items or ingredients in the “shopping cart” and proceed to “check-out” and pay for selected items or ingredients. Such website functionalities that produce the same, like, or similar results or functionalities are within the scope and spirit of various embodiments.

In a still further embodiment, the product provider 130 is an online grocer as described herein; however, a user may submit 760 a request for ingredients without directly interacting with the product provider 130 or the product provider's website 130. Additionally, a user may upload 740 a list of ingredients, save 745 the list of ingredients, send 750 an ingredient request configuration, save 755 the request for ingredients, or submit 760 a request for ingredients, through communications or interactions with the recipe server 120 instead of interactions with the product provider 130. In one embodiment, the communications with the product provider 130 may be with the recipe server 120 instead of with the product provider 130. Accordingly, a user would not require an account with a specific product provider 130, and could submit 760 a request for ingredients to the recipe server 120, which could use one or more product provider 130 to fulfill the request 760 for ingredients made by the user.

For example, a website such as Expedia.com allows a user to fulfill an order with a vendor without direct user interaction with the vendor. Accordingly, where a user desires to book a flight with Alaska Airlines, the user can book such a flight through Expedia.com instead of booking the flight directly at AlaskaAir.com. Such functionalities are within the scope and spirit of various embodiments.

In yet another embodiment, individual ingredients may be sponsored or otherwise associated with a specific brand name or producer of a given ingredient and a recipe that could be searched or selected having that ingredient would have the same ingredient sponsorship. As in the example above, there may be a first recipe for Chinese fried rice and a second recipe for seafood rice salad, but the ingredients ‘rice’ and “eggs” could be sponsored by producers of such ingredients and the recipes, ingredients, and list of ingredients could be displayed as follows.

The first recipe for Chinese fried rice would comprise: 4 cups Uncle Ben's® rice; 1 cup pork; 1 tbsp soy sauce; ½ cup oil; 2 Crystal Farms™ eggs; and ¼ cup peas, and a second recipe for seafood rice salad would comprise: 2 cups Uncle Ben's® rice; 7 oz tuna; 8 oz shrimp; and 3 Crystal Farms™ eggs, and the set of generated list of ingredients could be: 6 cups Uncle Ben's® rice, 1 cup pork; 1 tbsp soy sauce; ½ cup oil; 5 Crystal Farms™ eggs; and ¼ cup peas, 7 oz tuna; and 8 oz shrimp. Additionally, all other recipes that include eggs would display “Crystal Farms™ eggs” and all recipes that include rice would display “Uncle Ben's® rice.” When a user uploads 740 a list of ingredients, in addition to displaying a sponsored ingredient, the sponsored product would be purchased when the user submits a request for ingredients. Sales of sponsored products may be tracked thereby and sponsors may pay each time a sponsored product is ordered by a user through the recipe server 120. In another embodiment, sponsorship of ingredients could be changed at regular intervals or randomly among a group of sponsors or the like.

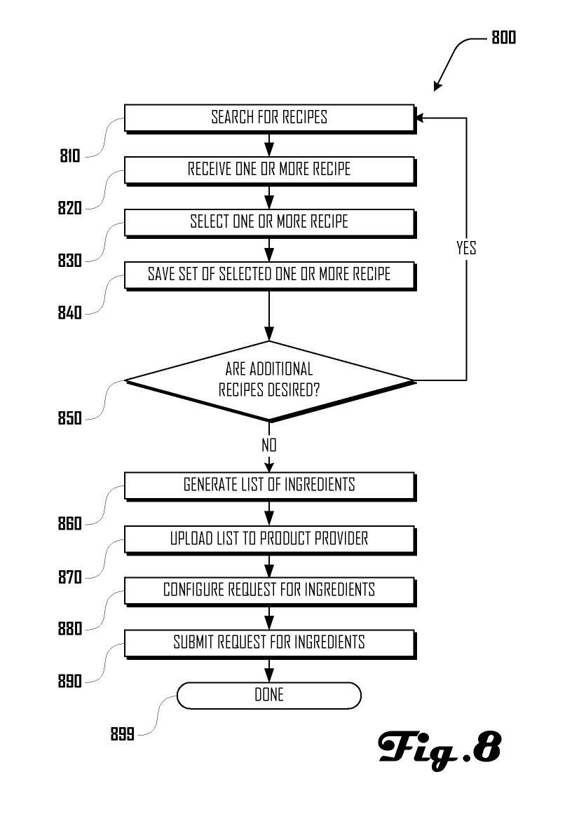

FIG. 8 is a flow diagram illustrating a routine for generating and submitting a request for at least one ingredient 800 in accordance with various embodiments. The routine for generating and submitting a request for at least one ingredient 800 begins at block 810, where a search is made for recipes, which as described herein, may be for one or more recipe according to a multitude of criteria. The routine continues to block 820 where one or more recipe is received, and then to block 830 where one or more recipe is selected, and then to block 840 where the set of selected one or more recipe is saved. In decision block 850, a determination is made whether additional recipes are desired in the saved set. If additional recipes are desired, then the routine loops back to block 810, where additional recipes are searched for. If additional recipes are not desired, then the routine continues to block 860 where a list of ingredients from the set of recipes is generated, and then on to block 870 where the list of ingredients is uploaded to a product provider 130. Then, in block 890, the request for ingredients is submitted and the routine is done 899.

In one embodiment, recipes, or recipes from a list may be associated with a calendaring function to provide meal planning and shopping list generation. For example, one or more recipe may be associated with one or more day of the week, month, or year to indicate that a user desires to use the recipe on a given day. Then, a user may generate a list of ingredients from all the recipes from a defined range of dates, a week, a month, or the like. For example, users that desire to purchase groceries for the coming week could create a list of ingredients from all of the recipes assigned to the coming week. Then, as described herein, the user may upload this list to a product provider 130, or may use the list of ingredients as a shopping list when visiting a grocery store. For example, a user may print a copy of the ingredients or transfer the list to a personal data assistant, cell phone or the like, and use the list while visiting a grocery store.

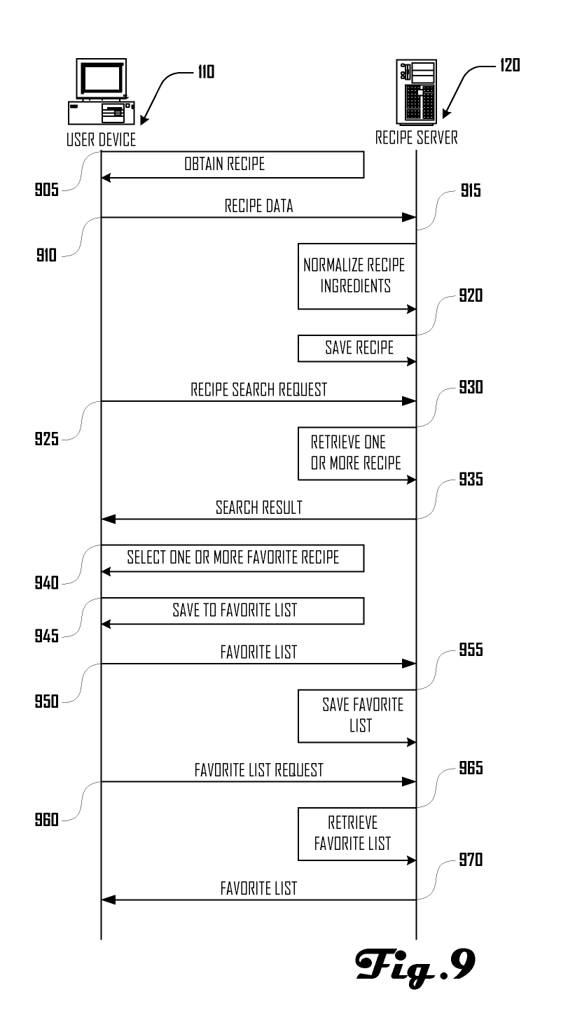

FIG. 9 is a diagram illustrating the actions taken by a user in the management and execution of recipes, in accordance with various embodiments, which depicts one exemplary series of communications between a user device 110 and a recipe server 120. The communications begin with a user obtaining 905 or generating a recipe. Obtaining 905 or generating a recipe may be done in a multitude of ways. For example, a user may obtain a recipe on the internet or from a cookbook or alternatively create a unique recipe.

Returning to the communications, the recipe data is uploaded 910, the recipe ingredients are normalized 915, and the recipe is saved 920. Normalization may comprise translation of the ingredients of the recipe to a limited set of ingredients as defined on the recipe server 120. This process may be done by a user or may be done by the recipe server 120 or both. The saved recipe may be available publicly to a user device 110 that searches the recipe server 120 for recipes, may be available publicly through a webpage, or may be only available to the user who created the recipe or to users defined by the user who created the recipe.

Again returning to FIG. 9, a search 925 may be performed for recipes, which may include the recipe that has been previously saved. One or more recipe is retrieved 930 and the one or more recipe is sent 935 to the user device 110. One or more favorite recipe is selected 940 from the one or more presented recipe, and a list of favorite recipes is saved 945. The list of favorite recipes may be sent 950 to the recipe server 120 and the list of favorite recipes may be saved 955. The user device 110 may send 960 a favorite list request, the favorite list may be retrieved 965, and the favorite list may be sent 970 to the user device 110.

Various embodiments comprise the multitude of sequences that these communications may be performed in and/or repeated in and that some communications need not be performed or these communications may be performed at various time intervals. Also, in one embodiment, there may be a plurality of lists with various names or other identifying moniker as described herein. In another embodiment, lists of recipes and recipes may be stored on the user device 110 or the user device 110 and the recipe server 120 may be a single device.

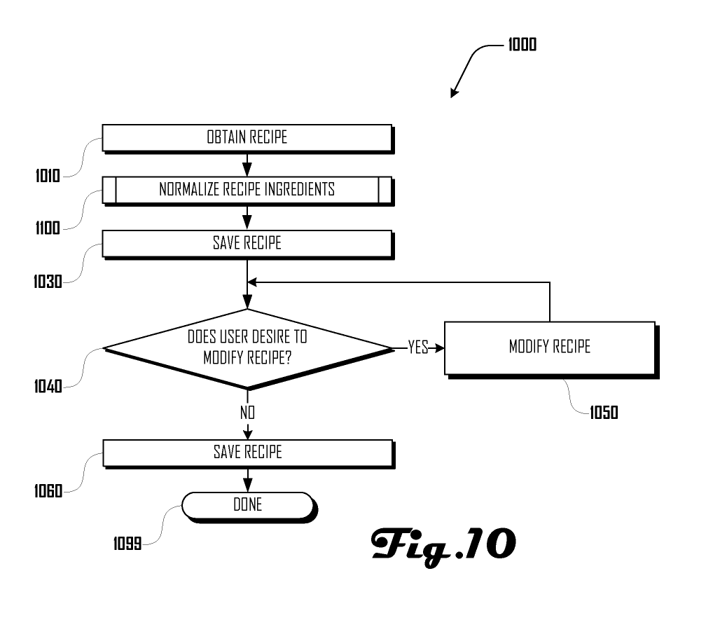

FIG. 10 is a flow diagram illustrating recipe normalization routine 1000 in accordance with various embodiments. The recipe normalization routine 1000 begins at block 1010 where a recipe is generated or obtained as described herein. The routine continues to sub-routine block 1100 where an ingredient normalization routine is performed. For example, in some embodiments, the recipe server 120 will extract the ingredients from the recipe and match them against a list of “all known ingredients” as defined by the recipe server 120. In another embodiment, a user is required to select ingredients from a set of defined ingredients when inputting a recipe. In block 1030 the recipe is saved.

In decision block 1040, a determination is made whether the user desires to modify the recipe. If the user does desire to modify the recipe, the routine continues to block 1050 where the user modifies the recipe, and then the routine loops back to decision block 1040 where a decision is again made whether the user desires to modify the recipe. If the user does not desire to modify the recipe, the routine continues to block 1060, where the recipe is saved and the routine is done 1099.

The steps depicted in FIG. 10 may be repeated in various embodiments. For example a user may upload and save a recipe and then return later to modify or edit it as the user desires. In another embodiment, other users who have access to the recipe may modify or edit the recipe. In a still further embodiment, a user may add or suggest an ingredient for a set of defined ingredients.

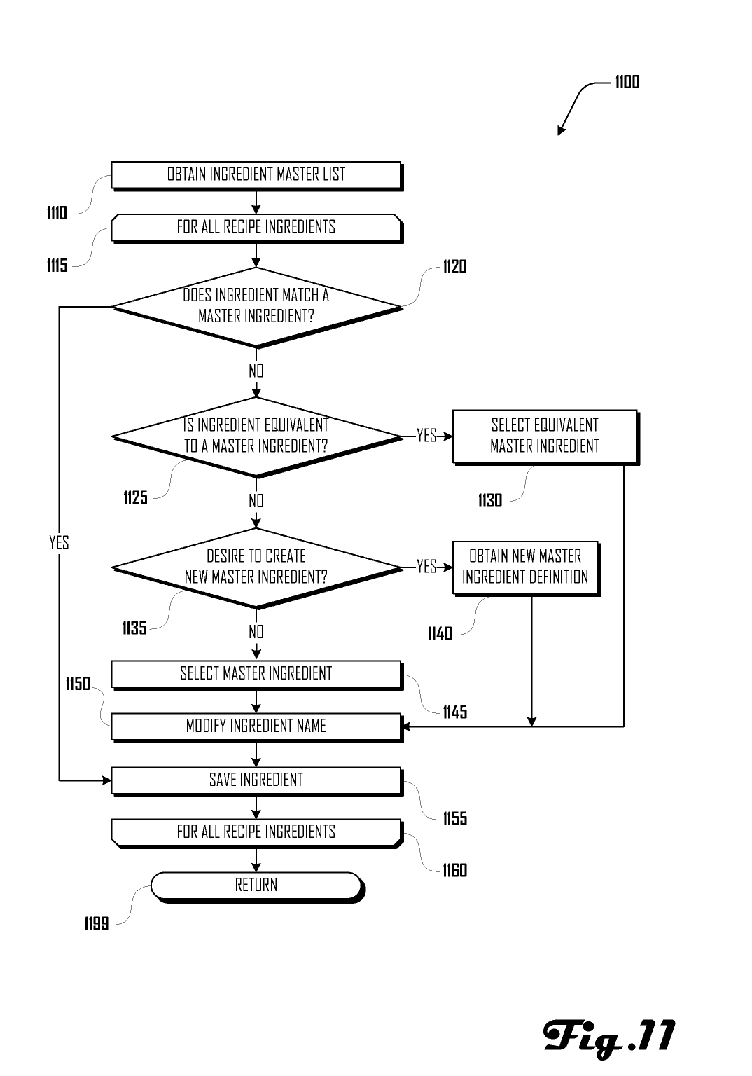

FIG. 11 is a block diagram illustrating an ingredient normalization sub-routine 1100 in accordance with various embodiments. The ingredient normalization sub-routine 1100 begins in block 1110, wherein an ingredient master list is obtained. As described herein, the ingredient master list may comprise a plurality of defined ingredients.

Looping block 1115 begins a loop for all recipes, and in decision block 1120, a determination is made whether a given ingredient matches a master ingredient. If the ingredient does match a master ingredient, the ingredient is saved in block 1155 and looping block 1160 ends the loop for all ingredients. However, if a given ingredient does not match a master ingredient, the ingredient normalization sub-routine 1100 continues to decision block 1125 where a determination is made whether the ingredient is equivalent to a master ingredient.

If the ingredient is equivalent to a master ingredient, then the ingredient normalization sub-routine 1100 continues block 1130 where the equivalent master ingredient is selected. In block 1150 the ingredient name is modified or changed to the master ingredient name and the ingredient is saved in block 1155. Looping block 1160 ends the loop for all ingredients.

However, if the ingredient is not equivalent to a master ingredient, then the ingredient normalization sub-routine 1100 continues to block 1135 where a determination is made whether a user desires to create or suggest a new master ingredient. For example, if no ingredient in the master list is found that is equivalent to a given ingredient, a user may desire to add the ingredient to the master ingredient list because the user may believe that the master ingredient list is deficient. Alternatively, a user may determine that the ingredient or recipe may be modified to include an ingredient that is in the ingredient master list or that an ingredient in the ingredient master list is suitably equivalent to the ingredient.

Accordingly, if the user desires to create a new master ingredient definition, a new master ingredient definition is obtained in block 1140. For example, a user can be presented with a list of suggested ingredient names and/or the user may input a suggested ingredient name. In block 1150 the ingredient name is modified to the new master ingredient definition and in block 11 55 the ingredient is saved. Looping block 1160 ends the loop for all ingredients.

However, if a user does not desire to create a new master ingredient, the user selects a master ingredient in block 1145, the ingredient name is modified or changed to the selected master ingredient name in block 1155 and the ingredient is saved in block 1155. Looping block 1160 ends the loop for all ingredients. The ingredient normalization sub-routine 1100 then returns 1199. In various embodiments, a user can choose to omit an ingredient from the recipe.

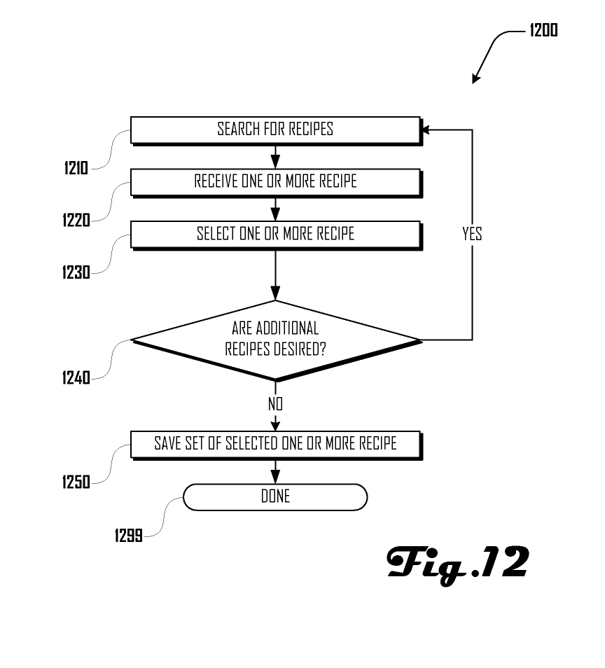

FIG. 12 is a flow diagram illustrating a routine for creating and saving a list of one or more recipe in accordance with various embodiments. The routine begins at block 1210 where a search is performed for recipes. The routine then continues to block 1220 where one or more recipe is received incident to the search, and then to block 1230 where one or more recipe is selected. In decision block 1240, a determination is made whether additional recipes are desired. If additional recipes are desired, the routine loops back to block 1210 where a search is performed for recipes. If additional recipes are not desired, then the routine continues to block 1250 where the set of selected one or more recipe is saved and the routine is done 1299.

Additionally, in one embodiment, a user may choose to perform other functions with the one or more received recipe, including, but not limited to, associating the recipe with a calendar date, adding one or more ingredients to a shopping cart, reading reviews on a recipe, printing the recipe, emailing the recipe to a friend, or the like.

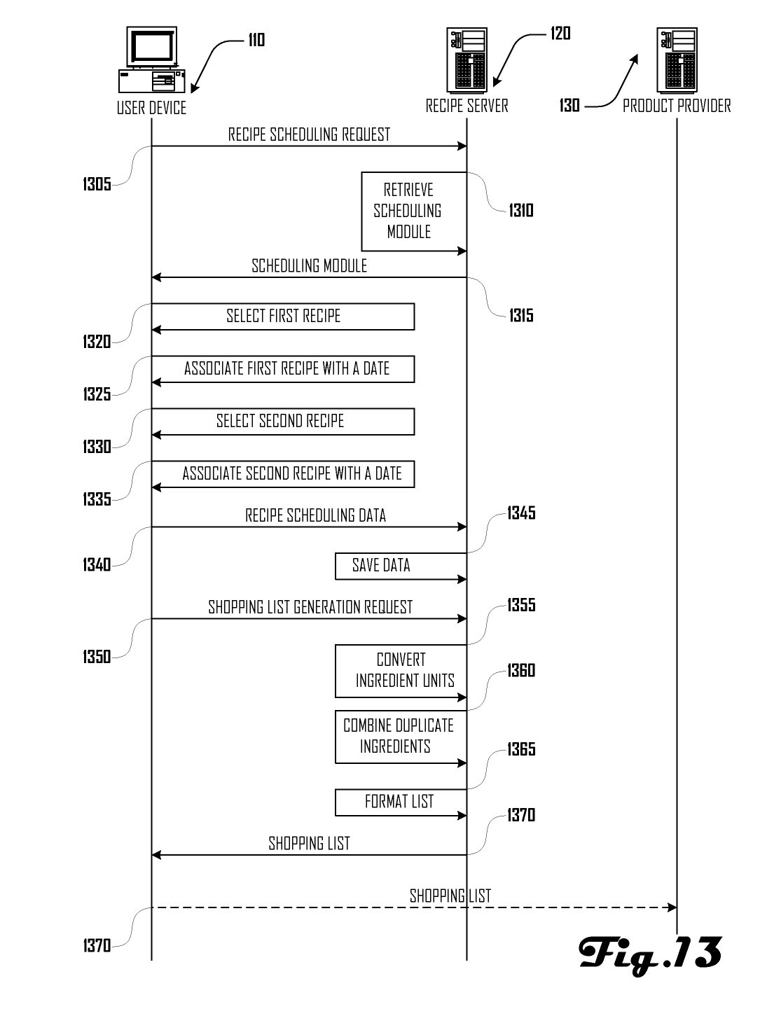

FIG. 13 is a diagram illustrating actions taken by a user device 110, recipe server 120 and a product provider 130 in accordance with an embodiment. The actions begin where a recipe scheduling request is sent 1305 to the recipe server 120 and scheduling module data is retrieved 1310. The scheduling module data is sent 1315 to the user device 110. For example, a user may view a webpage graphic user interface and initiate a scheduling function within the graphic user interface, which may cause a scheduling module 510 or similar functionality to be presented to the user.

Returning to the actions, a first recipe is selected 1320 and the first recipe is associated 1325 with a given date. A second recipe is selected 1330 and the second recipe is associated 1335 with a date. For example, in various embodiments, a user can select one or more recipe and associate the recipe with a given date, time, week, month or the like. Additionally, a given recipe may be associated with one or more date, or may be associated with a given date multiple times.

Returning again to the actions, the recipe scheduling data is sent 1340 to the recipe server 120, where the scheduling data is saved 1345. A shopping list generation request may then be sent 1355 to the recipe server 120, and the recipe server 120 may convert 1355 the ingredient units to standardized units, combine 1360 duplicate ingredients and format 1365 a shopping list. The shopping list may then be sent 1370 to a product provider 130, which is an optional action in some embodiments. In various embodiments, a shopping list can be sent to a user device 110 or other device via e-mail, text message, and the like. In a further embodiment, a shopping list can be sent to a product provider 130 by a user device 110 a recipe server 120, and the like.

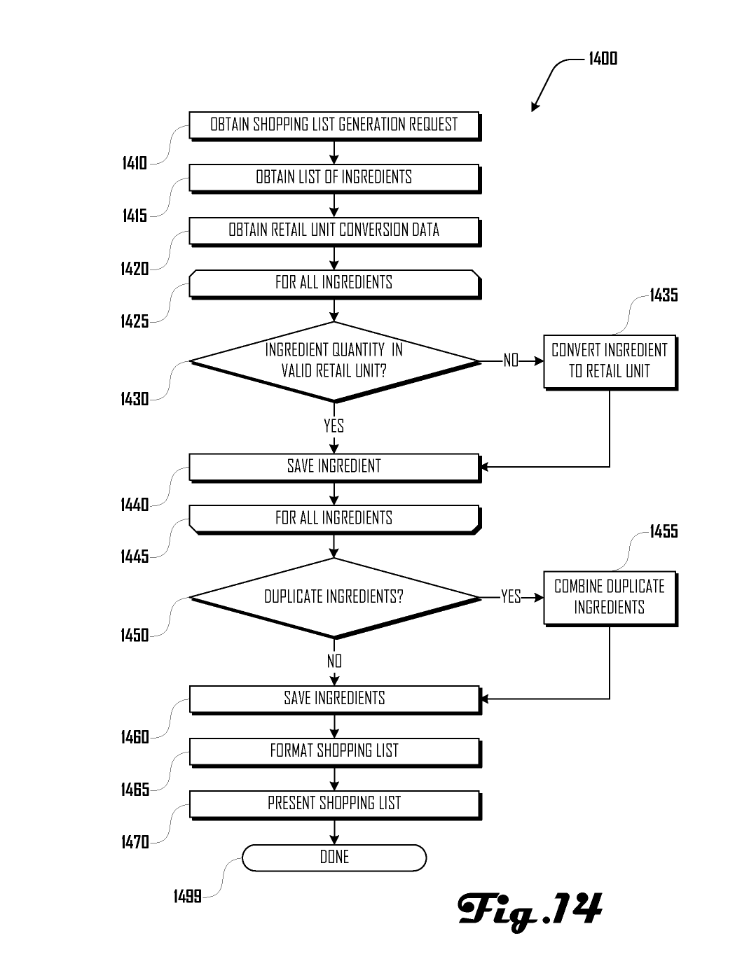

FIG. 14 is a block diagram illustrating a shopping list generation routine 1400 in accordance with an embodiment. The shopping list generation routine 1400 beings in block 1410 wherein a shopping list generation request is obtained, and in block 1415 a list of ingredients is obtained. In block 1420, retail unit conversion data is obtained.

For example, unit conversion data may comprise data that facilitates conversion of ingredients to units that such ingredients come packaged and units that are present in items sold in retail or wholesale establishments. In various embodiments, such a conversion may be desirable because ingredient units present in a recipe may not correspond to how a given ingredient is sold. For example, a common cooking unit is a “cup” or a “tablespoon;” however, food ingredients are rarely sold in such quantities. Instead, food ingredients are commonly sold in units of weight, and sometimes volume. Common retail units include ounces (oz) and pounds (lbs). Accordingly conversion data from common cooking units to common retail units is desirable in various embodiments.

Returning to the shopping list generation routine 1400, looping block 1425 begins a loop for all ingredients and in decision block 1430 a determination is made whether the ingredient quantity is in a valid retail unit. If so, the ingredient is saved; however, if the ingredient is not in a valid retail quantity, then the shopping list generation routine 1400 continues to block 1435 where the ingredient is converted to a retail unit, and the ingredient is saved in block 1440. Looping block 1445 ends the loop for all ingredients.

In decision block 1450 a determination is made whether duplicate ingredients exist. If duplicate ingredients do exist, the shopping list generation routine 1400 continues to block 1455 where duplicated ingredients are combined and the ingredients are saved in block 1460. However, if duplicate ingredients do not exist, the ingredients are saved in block 1460, a shopping list is formatted in block 1465, and a shopping list is presented in block 1470. The shopping list generation routine 1400 is then done.

As described above, some embodiments may be directed towards cooking, recipes for cooking, and food products or food ingredients. These embodiments have been used for the purpose of illustration only, and other embodiments may be directed towards a method, routine or set of instructions that comprises one or more ingredient, item, product, good or service. For example, in one embodiment, construction projects may be managed and executed. A manager may search for or create one or more recipe for constructing a portion of a project such as a set of cabinets, a bathroom, framing a house, or furnishing a house, and the like. As described herein, the manager may associate each recipe with a given day of a week, month or year and then generate a list of all tools, services, equipment and/or materials that will be required to perform each of the tasks within a given week, month, or other designated range of dates, which is generated from recipes within the given week, month, or other designated range of dates. Then the manager may upload the list of tools, services, equipment and/or materials to a product provider 130 or may use the list to purchase the tools, services, equipment and/or materials at a hardware store or other suitable location.

Additionally, although specific embodiments have been illustrated and described herein, it will be appreciated that a wide variety of alternate and/or equivalent implementations may be substituted for the specific embodiment shown in the described without departing from the scope of the embodiments described herein. This application is intended to cover any adaptations or variations of the embodiment discussed herein. Therefore, it is manifested and intended that the invention be limited only by the claims and the equivalents thereof. While preferred and alternate embodiments of the invention have been illustrated and described, as noted above, many changes may be made without departing from the spirit and scope of the invention. Accordingly, the scope of the invention is not limited by the disclosure of these preferred and alternate embodiments.

1. A computer implemented method of recipe management and implementation, the method comprising:
obtaining unit conversion data;
obtaining an ingredient master list;
obtaining a set of recipes, wherein a recipe comprises a set of ingredients that have a unit and correspond to said ingredient master list;
selecting at least two recipes from said set of recipes; and
generating an ingredient shopping list by:
converting the units of the ingredients of said at least two recipes based on said unit conversion data; and
combining duplicate ingredients.

2. The method of claim 1, further comprising associating at least two recipes with at least one date.

3. The method of claim 2 further comprising selecting a date range that comprises said at least one date associated with said at least two recipes.

4. The method of claim 2 wherein said at least two recipes are associated with at least one date via a recipe scheduling module.

5. The method of claim 1 wherein said ingredient shopping list is generated via a shopping list generation module.

6. The method of claim 1 wherein obtaining said set of recipes comprises normalizing the ingredients comprising said set of recipes.

7. The method of claim 1 wherein one or more ingredient is sponsored.

8. The method of claim 1 further comprising facilitating an ingredient request.

9. The method of claim 8, wherein said ingredient request comprises an ingredient of said ingredient shopping list.

10. The method of claim 9, wherein said ingredient is sponsored.

11. The method of claim 8, wherein said facilitating comprises a communication with a product provider.

12. The method of claim 11, wherein said communication comprises said ingredient shopping list.

13. The method of claim 11, wherein said product provider is an online grocer.

14. A computing device having a processor and a memory with computer executable instructions which, when executed by said processor, perform the method of claim 1.

15. A computer readable medium having executable instructions, which when executed perform the method of claim 1.

16. A computer implemented method of recipe management and implementation comprising:
obtaining:
unit conversion data,
an ingredient master list; and
a set of recipes,
wherein a recipe comprises a set of normalized ingredients that have a unit and correspond to said ingredient master list;
selecting at least two recipes from said set of recipes; and
generating an ingredient request by:
converting the units of the ingredients of said at least two recipes based on said unit conversion data; and
combining duplicate ingredients.

17. The method of claim 16 further comprising sending said ingredient request to a product provider.

18. The method of claim 17, wherein said product provider is an online grocer.

19. A computer readable medium having executable instructions, which when executed perform the method of claim 16.

20. A computing device for management and execution of a recipe, comprising:
a database comprising:
unit conversion data,
an ingredient master list; and
a set of recipes,
wherein a recipe comprises a set of normalized ingredients that have a unit and correspond to said ingredient master list;
a recipe search module operable to select at least two recipes from said set of recipes;
a recipe scheduling module operable to associate said at least two recipes with at least one date; and,
a shopping list generation module operable to generate an ingredient shopping list by converting the units of the ingredients of said at least two recipes based on said unit conversion data and combining duplicate ingredients.
